(19) United States
(12) Patent Application Publication
(10) Pub. No.: US 2025/0214204 A1
(43) Pub. Date: Jul. 3, 2025

(54) Rotatable Handle Bar Clamp

(71) Applicant: Stanley Black & Decker, Inc., New Britain, CT (US)

(72) Inventors: Ralf Strauss, Stanley, NC (US); Stephen Rowlay, Derbyshire (GB)

(21) Appl. No.: 18/867,230

(22) PCT Filed: May 19, 2023
(86) PCT No.: PCT/US2023/022887

§ 371 Date: Nov. 19, 2024

Related U.S. Application Data
(60) Provisional application No. 63/344,492, filed on May 20, 2022.

(51) Int. Cl. B25B 5/06; B25B 5/16

(52) U.S. Cl. CPC B25B 5/068; B25B 5/163

(57) ABSTRACT

According to an embodiment, a bar clamp includes a bar, a fixed jaw, and a movable jaw assembly having an actuator portion and a jaw portion. The movable jaw assembly is configured to move along the bar towards or away from the fixed jaw. At least one of the actuator portion and the jaw portion is configured to rotate around the bar. According to another embodiment, where a bar clamp comprises a bar, a fixed jaw, a movable jaw, and a movable jaw actuator, a method of operating the bar clamp includes rotating one of the movable jaw actuator and the movable jaw about the bar while the fixed jaw and the bar remain stationary, and using the movable jaw actuator to move the movable jaw along the bar towards or away from the fixed jaw.

### CROSS-REFERENCE TO RELATED APPLICATIONS

The present application is a U.S. National Stage Application under 35 U.S.C. § 371 of PCT Application No. PCT/US2023/022887, filed May 19, 2023, which claims the benefit of U.S. Provisional Application No. 63/344,492, filed on May 20, 2022, the entire contents of each of which are hereby incorporated herein by reference.

### FIELD OF THE INVENTION

The present invention relates to bar clamps or spreaders (such tools collectively referred to herein as bar clamps, as most such bar clamps or spreaders may be converted between a clamping mode and a spreading mode) with actuators to incrementally move a movable jaw against or away from a fixed jaw.

### BACKGROUND

Conventional bar clamps include a trigger or other actuator that may be engaged by a user squeezing on the actuator against a handle to move an actuator mechanism along a bar, thus moving a movable jaw associated with the actuator mechanism relative to a fixed jaw fixed relative to the bar. It may be appreciated that depending on workpiece configuration and handedness of the user, a particular orientation of the actuator relative to the jaw may be cumbersome. Among other things, the present disclosure improves upon known actuator mechanisms on bar clamps.

### SUMMARY OF THE INVENTION

According to an embodiment a bar clamp includes a bar, a fixed jaw, and a movable jaw assembly having an actuator portion and a jaw portion. The movable jaw assembly is configured to move along the bar towards or away from the fixed jaw. At least one of the actuator portion and the jaw portion is configured to rotate around the bar.

According to another embodiment, where a bar clamp comprises a bar, a fixed jaw, a movable jaw, and a movable jaw actuator, a method of operating the bar clamp includes rotating one of the movable jaw actuator and the movable jaw about the bar while the fixed jaw and the bar remain stationary, and using the movable jaw actuator to move the movable jaw along the bar towards or away from the fixed jaw.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

Features of bar clamps in accordance with one or more embodiments are shown in the drawings, in which like reference numerals designate like elements. The drawings form part of this original disclosure in which:

FIG. 1 illustrates a perspective view of a first embodiment of a bar clamp having a movable jaw assembly and a fixed jaw assembly, having an actuator portion of the movable jaw assembly in a first position.

FIG. 2 illustrates a perspective view of the first embodiment of a bar clamp, having the actuator portion in a second position.

FIG. 3 illustrates the perspective view of FIG. 1, with cover plates removed so mechanisms therein are visible.

FIG. 4 illustrates an isolated and partially exploded perspective view of a rotatable assembly coupled to the actuator portion of the first embodiment.

FIG. 5 illustrates a side view of the rotatable assembly as engaging a mount portion extending therein from the actuator portion, with a cover thereof omitted to show the engagement.

FIG. 6 illustrates an exploded view of an embodiment of the fixed jaw of the first embodiment, as configured to engage the bar.

FIG. 7 illustrates a perspective view of a second embodiment of a bar clamp having a movable jaw assembly and a fixed jaw assembly, having an actuator portion of the movable jaw assembly in a first position.

FIG. 8 illustrates an isolated enlarged perspective view of the movable jaw assembly of the second embodiment, with a cover removed to show engagement between the actuator portion and a jaw portion of the movable jaw assembly.

FIG. 9 illustrates another perspective view of the actuator portion of FIG. 8, with a rotation actuator and the jaw portion moved off of the bar to better illustrate features thereof.

FIG. 10 illustrates an exploded front view of portions of the second embodiment of the bar clamp to better illustrate features thereof.

FIG. 11 illustrates an opposing perspective view as that of FIG. 8, with a housing of the actuator portion also omitted, showing engagement between the rotation actuator and a toothed member fixed relative to the jaw portion of the movable jaw assembly.

FIG. 12 illustrates a view similar to FIG. 11 for a third embodiment, where the toothed member of the third embodiment is configured as a slip toothed region to permit rotational movement of the actuator portion relative to the jaw portion through application of a rotational force to the actuator portion.

### DETAILED DESCRIPTION OF THE ILLUSTRATED EMBODIMENT(S)

An aspect of this invention may comprise a bar clamp where the actuator mechanism is rotatable about the bar, so that actuation may be performed when a user is clamping from the underside of a workpiece (e.g., at the edge of a support surface), or actuation may be performed when clamp is placed on the support surface, so that the actuator mechanism has been positioned above the support surface.

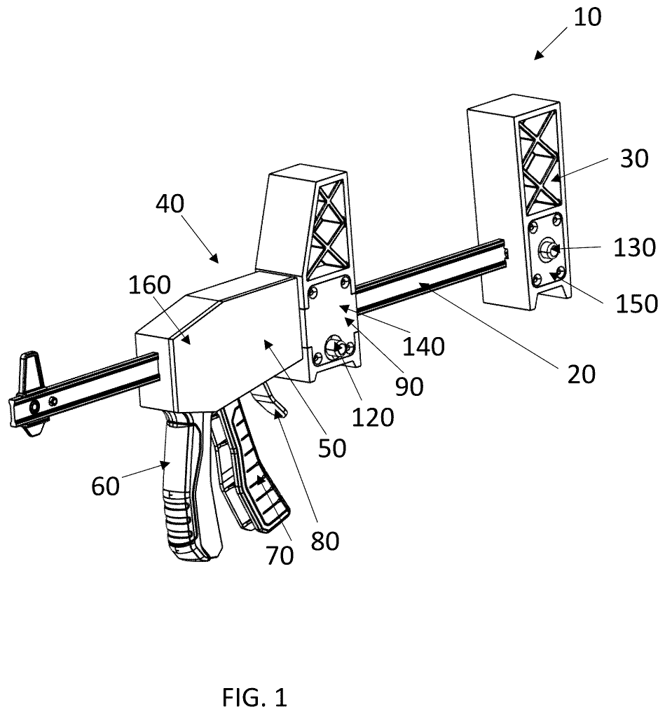

As shown in FIG. 1, in an embodiment a bar clamp 10 of the present disclosure may include a bar 20 with a fixed jaw 30 and a movable jaw assembly 40 mounted thereon. Coupled to the movable jaw is an actuator 50 described in greater detail below, which facilitates moving the movable jaw assembly 40 along the bar 20 towards the fixed jaw 30 in the configuration shown in FIG. 1, or may facilitate moving the movable jaw assembly 40 along the bar 20 away from the fixed jaw 30 when the fixed jaw 30 is positioned opposite the movable jaw assembly 40 so that the bar clamp 10 is reconfigured as a spreader, as is understood in the art.

In the illustrated embodiment, the movable jaw assembly 40 includes an actuator portion 50 that includes extending therefrom a handle 60, a trigger 70, and a release lever 80. The movable jaw assembly 40 further includes a rotatable assembly 90, discussed in greater detail below.

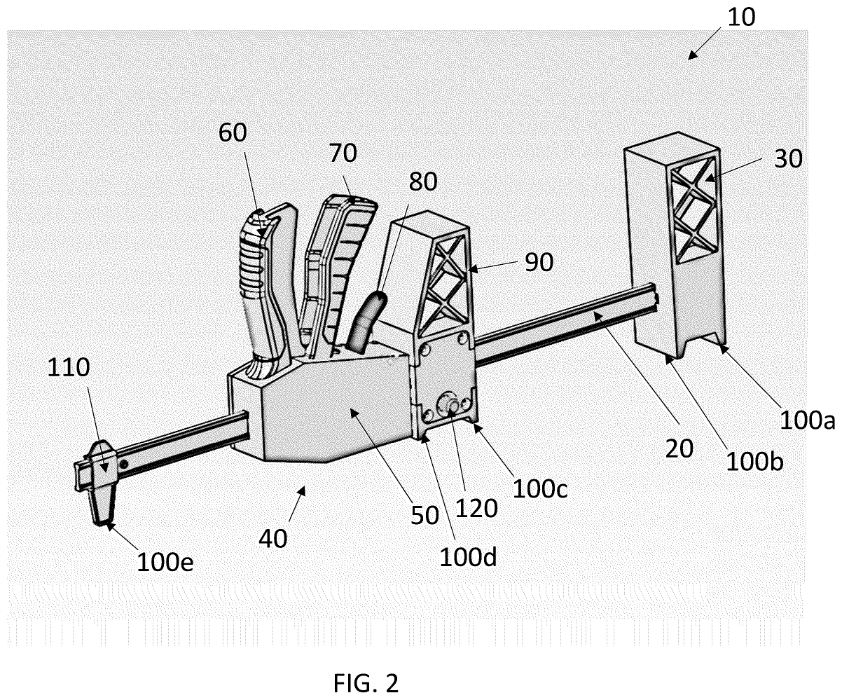

It is an aspect of the present disclosure that the fixed jaw 30 and the rotatable assembly 90 may be rotated about the bar 20 so that the handle 60, trigger 70, and release lever 80 extend in a same direction relative to the bar 20 as the majority extension of the rotatable assembly 90 and the fixed jaw 30. It may be appreciated that such rotation, the effect of which may be appreciated in FIG. 2, may facilitate positioning the bar clamp 10 on a support surface so that the bar clamp 10 may balance on legs (e.g., legs 100a-e) positioned along the extent of the bar clamp 10 to hold the bar clamp 10 upright on the support surface without interference from the extent of the handle 60, trigger 70, or release lever 80. In the illustrated embodiment, a pair of legs 100a and 100b are located on the fixed jaw 30, a pair of legs 100c and 100d are located on the rotatable assembly 90, and a leg 100e is located on a flange 110 on the bar 20. It may be appreciated that in embodiments including the flange 110, the flange 110 may be removed so that the fixed jaw 30 may be inserted in its place, facilitating using the bar clamp 10 as a spreader.

As further shown in FIG. 1 and partially shown in the view of FIG. 2, the rotatable assembly 90 may include a rotation actuator 120, while the fixed jaw 30 may include a removal actuator 130. While various assembly configurations may be utilized across embodiments, in the illustrated embodiment the rotatable assembly 90 includes a cover plate 140, while the fixed jaw 30 includes a cover plate 150. Similarly, the actuator portion 50 includes a cover plate 160. The cover plates 140, 150, and 160 may be secured with threaded fasteners or by any other appropriate mechanism in such embodiments, which may facilitate assembly or disassembly of the bar clamp 10.

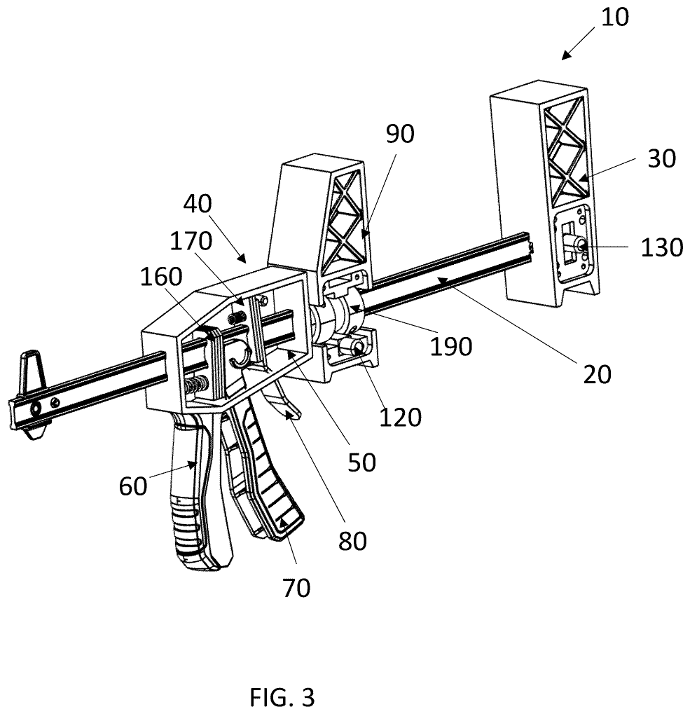

FIG. 3 illustrates the view of FIG. 1 with the cover plates 140, 150, and 160 removed so that the mechanisms of the embodiment of bar clamp 10 may be appreciated. As shown, in an embodiment the actuator portion 50 may include wedging plates 170 coupled to the release lever 80, and may include entraining slide plates 180 coupled to the trigger 70, as such features are known in the art. As further shown, a mount portion 190 of the actuator portion 50 (e.g., fixed to or integrally formed therewith) may extend into the rotatable assembly 90, and may be configured to selectively engage with the rotation actuator 120 as described in greater detail below, to permit rotation of the rotatable assembly 90 about the mount portion 190 and thus the bar 20 extending through the mount portion 190.

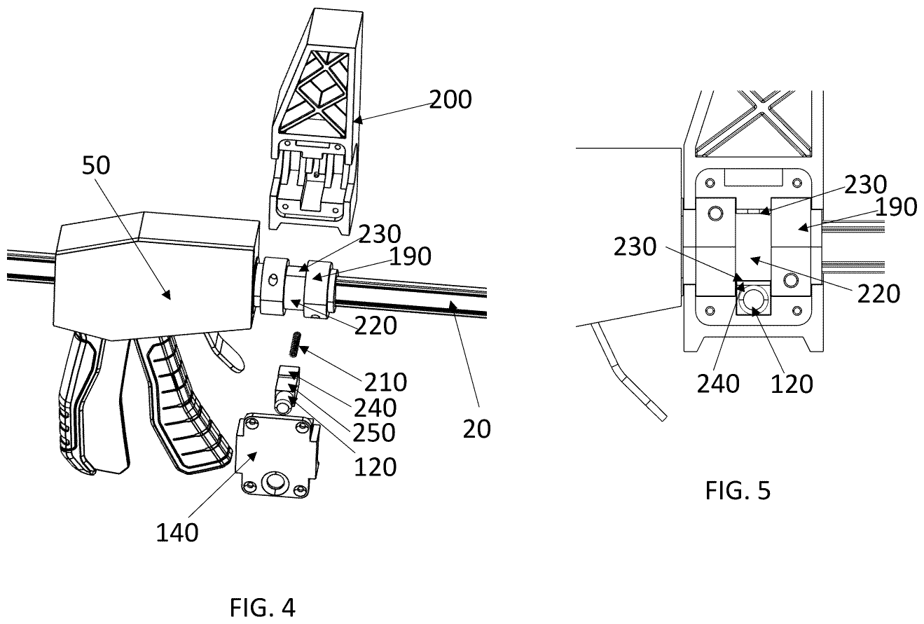

FIG. 4 illustrates an isolated and partially exploded view, with the actuator portion 50 intact on the bar 20, while the rotatable assembly 90 is in exploded view. As shown, the rotatable assembly 90 includes a rotatable jaw 200, alongside the rotation actuator 120 and the cover plate 140. As further shown, a spring 210 may bias the rotation actuator 120 out of the cover plate 140. As shown in FIG. 4, and may be more clearly seen in FIG. 5, the mount portion 190 of the actuator portion 50 may include a pair of curved rotation surfaces 220 (only one visible in the views, the other opposite), and a pair of index surfaces 230 (both seen in FIG. 5). Similarly, the rotation actuator 120 may include an index surface 240 and a rotation facilitating surface 250 coupled thereto or formed therewith. It may be appreciated that while the spring 210 biases the rotation actuator 120 outward, the index surface 240 may align with either of the index surfaces 230, locking the rotatable assembly 90 in an associated index position relative to the bar 20. By pressing the rotation actuator 120 inward, the index surface 210 may push away from the index surface 230, so that the rotatable assembly 90 may rotate relative to the mount portion 190, with the curved rotation surfaces 220 rotating in a space opened by the rotation facilitating surface 250. Once rotated such that the orientation of the rotatable jaw 200 is flipped across the bar 20, the other index surface 230 will be exposed to the rotation facilitating surface 250, such that the spring 210 may push the index surface 240 against the other index surface 230, locking the rotatable jaw 200 in the inverted position for the rotatable assembly 90 shown in FIG. 2.

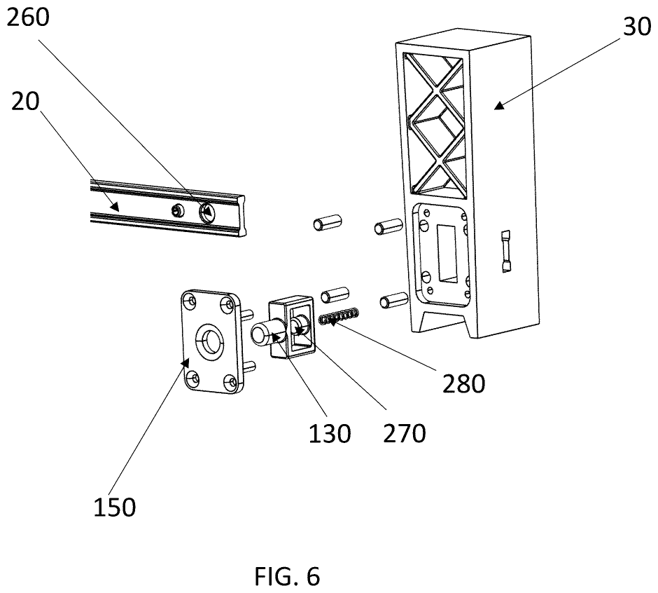

In the illustrated embodiment, the fixed jaw 30 may then be flipped by pressing the removal button 130, and removing and inverting the fixed jaw 30 on the bar 20. As shown in the exploded view of FIG. 6, the bar 20 may include an indexing hole 260 which may be engaged by lock 270 that is coupled or fixed to the removal button 130. In an embodiment, the lock 270 (and actuator 130) may be spring biased by a spring 280. Accordingly, pressing the removal button 130 removes the lock 270 from the hole 260, allowing the fixed jaw 130 to be removed from the bar 20.

While the embodiment of the bar clamp 10 as illustrated in FIGS. 1-6 requires multiple steps to move the bar clamp 10 from the first configuration of FIG. 1 to the inverted configuration of FIG. 2, in other embodiments bar clamps may be configured so that structure analogous to the actuator portion 50 is rotatable while the structure analogous to the rotatable jaw 200 and the fixed jaw 30 remain in the same position on the bar 20. In such configurations, it may be appreciated that less steps are required to change the configuration of the bar clamp thereof. Embodiments of such bar clamps are described in greater detail below.

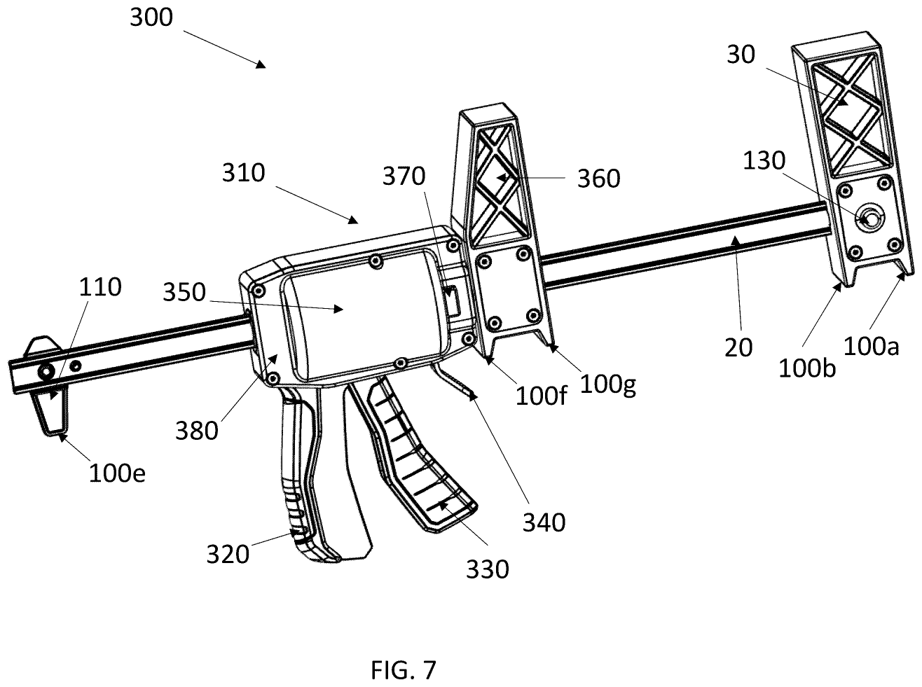

As shown in FIG. 7, a bar clamp 300 includes features such as the bar 20 and the fixed jaw 30 that may be the same as those described above. Instead of the movable jaw assembly 40, however, the bar clamp 300 includes a movable jaw assembly 310 as described below. The movable jaw assembly 310 includes a handle 320 which may be generally similar to the handle 60 disclosed above. The movable jaw assembly 310 also includes a trigger 330 which may be generally similar to the trigger 70 disclosed above. Furthermore, the movable jaw assembly 310 includes a release lever 340 which except as discussed in greater detail below may be generally similar to the release lever 80 disclosed above.

It is an aspect of the present disclosure that an actuator portion 350 of the movable jaw assembly 310 may rotate about the bar 20 while a jaw portion 360 remains in the same position relative to the bar 20 without rotating. Accordingly, by rotating the actuator portion 350, protruding structures such as the handle 320, the trigger 330, and the release lever 340 may be moved out of a plane onto which the bar clamp 300 may rest, e.g., one defined by legs 100a and 100b of fixed jaw 30, leg 100e of flange 110, and legs 100f and 100g of the jaw portion 360.

As further shown in FIG. 7, the actuator portion 350 may include a rotation actuator 370, described in greater detail below, which may facilitate rotation of the actuator portion 350 of the movable jaw assembly 310. While various assembly configurations may be utilized across embodiments, in the illustrated embodiment the actuator portion 350 includes a cover plate 380, which may be secured with threaded fasteners or by any other appropriate mechanism in such embodiments, which may facilitate assembly or disassembly of the bar clamp 300.

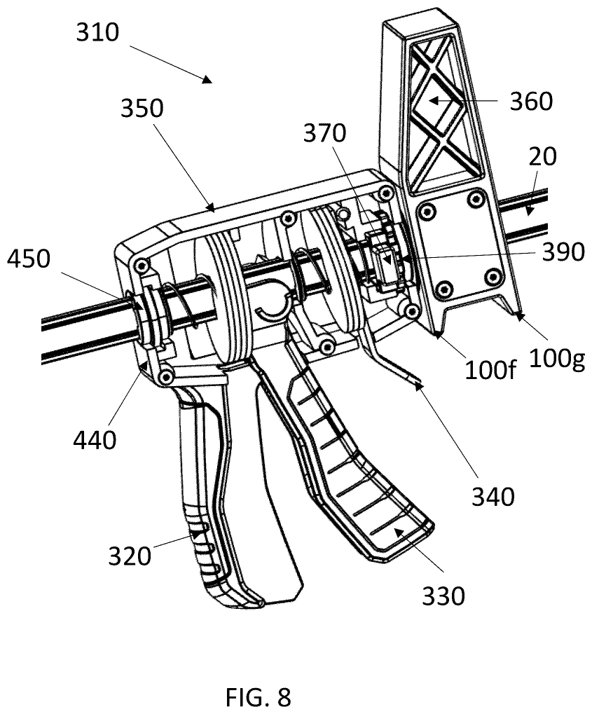

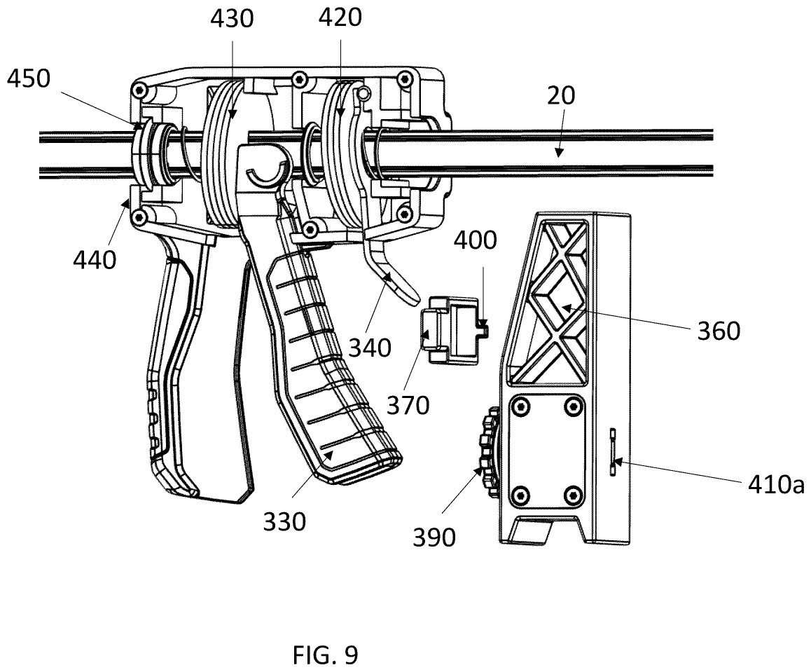

FIG. 8 illustrates an enlarged view of the movable jaw assembly 310 on the bar 20, with the cover plate 380 removed so that internal features thereof may be appreciated. Reference may also be made to FIG. 9, showing another perspective view with the rotation actuator 370 and jaw portion 360 moved off of the bar 20 to be seen in greater detail. As shown, the jaw portion 360 includes a toothed member 390 having a plurality of indexing regions thereon extending into the actuator portion 350. A lock 400 of the rotation actuator 370 may selectively engage the indexing regions as the actuator portion 350 selectively rotates about the bar 20 (and the toothed member 390). As shown, where the bar 20 has an I-beam configuration (with or without serifs/crossbars) the shape of a non-rotatable slot 410a on the jaw portion 360 may prevent rotation of the jaw portion 360. Further shown in FIGS. 8 and 9, wedging plates 420 coupled to the release lever 340, and entraining slide plates 430 coupled to the trigger 330 may have a rotationally symmetrical configuration such that a housing 440 of the actuator portion 350 may rotate about the wedging plates 420 and the entraining slide plates 430 when the rotation actuator 370 is actuated and the externally engageable features of the actuator portion 350 are rotated relative to the jaw portion 360 and the bar 20. While in the illustrated embodiment the wedging plates 420 and entraining slide plates 430 have a circular cross section, other multifaceted shapes capable of supporting rotation of the housing 440 thereabout may be utilized in other embodiments.

It may be appreciated that the handle 320 may be fixed to the housing 440, while the trigger 330 and the release lever 340 may be configured to be carried by the housing 440 for rotation about the bar 20 when the rotation actuator 370 is pressed to disengage the lock 400 from the toothed member 390. Further shown in FIGS. 8 and 9 is that a housing cap 450 may have a curved surface or other shape that may rotatably support the housing 440, so that it encloses the actuator portion 350 while the housing 440 rotates about the bar 20 and the housing cap 450.

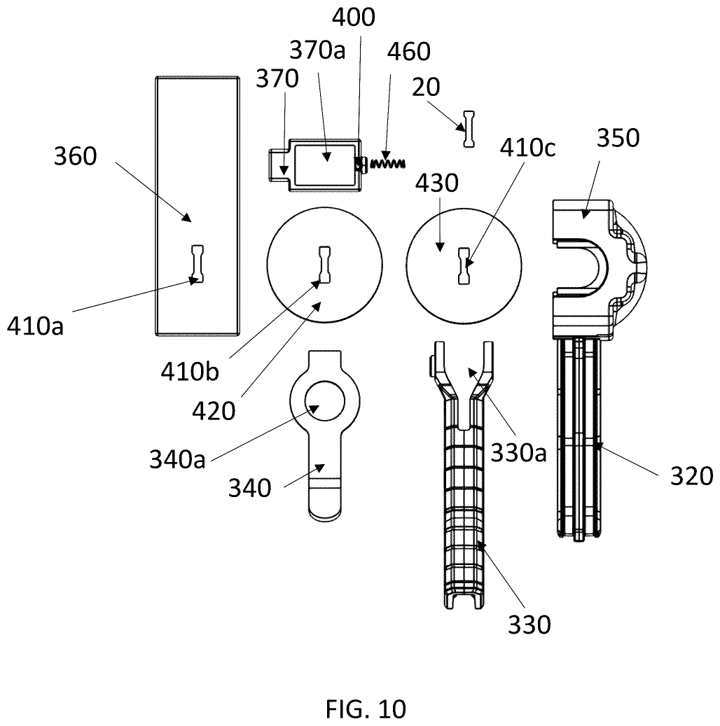

Turning to FIG. 10, a front exploded view of portions of the bar clamp 300 is illustrated, showing how certain structures, such as the wedging plates 420 and entraining slide plates 430 may also include non-rotatable slots 410b and 410c respectively, while other structures may be configured for rotation about the bar 20, including the release lever 340 having a rotatable slot 340a, the trigger 330 having a gap 330a where it may mount to the housing 350, and the rotation actuator 370 including a wide opening 370a so that the bar 20 may rotate within. Further shown in the front view is where a spring 460 may bear between the rotation actuator 370 and the housing 350, so as to spring bias the rotation actuator 370 to engage the lock 400 into the toothed member 390 of the jaw portion 360.

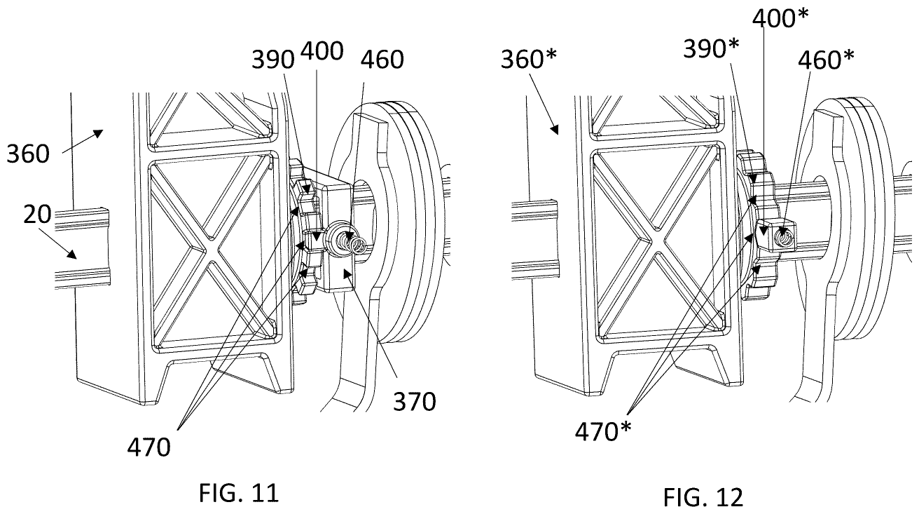

The spring 460 and how the lock 400 may engage with the toothed member 390 may be more clearly seen in FIG. 11, showing an opposing perspective view as that of FIG. 8, with the housing 440 of the actuator portion 350 also omitted. As shown, the toothed member 390 may have a plurality of indexing regions 470, into which the lock 400 may be inserted into. Accordingly, as the actuator portion 350 is rotated relative to the jaw portion 360 and the bar 20, various angles of orientation for the handle 320, trigger 330, and release lever 340 may be achieved relative to the jaw portion 360 and the fixed jaw 30 shown in FIG. 7.

While in the embodiment of the bar clamp 300 the lock 400 must be manually pushed out of the indexing regions 470 to permit rotation, it may be appreciated that in other embodiments the toothed region 390 may be configured so that a rotational force may be applied to force disengagement of the lock without pressing of a rotation actuator 370. For example, as shown in FIG. 12, a slip toothed region 390* may be provided on a jaw portion, where rotational force applied to a housing bearing against a lock 400* spring biased by a spring 460* from between a housing (omitted) and the slip toothed region 390* may cause the lock 400* having angled sidewalls to slip out of angled sidewalls defining slip indexing regions 470*. It may be appreciated that other rotational engagements may be utilized in various embodiments, including but not limited to detents, or clamping mechanisms to selectively clamp the actuator portion 350 to the bar 20 and or the jaw portion 360.

Other mechanisms wherein the actuator portion (e.g., actuator portion 350) or the jaw portion (e.g., jaw portion 360) are rotatable relative to each other about an axis of the bar (e.g., bar 20) may also be appreciated through the disclosed embodiments or combinations of the teachings therein. For example, in some embodiments the actuator portion may be disengageable from the jaw portion, and configured to be removable from the bar, permitting rotation of the actuator portion to be manually rotated, reinserted in a rotated orientation on the bar, then reengage with the jaw portion. In some embodiments, the housing of the actuator portion may be configured to maintain a path for the bar to be re-inserted, without the internals of the actuator portion (e.g., plates analogous to the wedging plates 420 and entraining slide plates 430) becoming misaligned when no longer bearing against the bar. An example of an actuator portion having such a configuration may include, for example, that disclosed as the motor unit of U.S. Pat. No. 7,090,209, incorporated herein by reference in its entirety. Methods of using such bar clamps as those described herein may also be appreciated by this disclosure.

The objects, features, and characteristics of the present invention, as well as the methods of operation and functions of the related elements of structure and the combination of parts and economies of manufacture, may be apparent upon consideration of the description and drawings herein, all of which form a part of this specification. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used herein, the singular form of “a”, “an”, and “the” include plural referents unless the context clearly dictates otherwise.

In various embodiments, tools and components thereof described herein may be formed of combinations of metal, plastic, ceramic, or any other appropriate material. It may be appreciated that the components described herein may be of different constructions or configurations, including but not limited to one or more being comprised of different material choices. For example, various components described herein may each be constructed from a variety of materials, including but not limited to one or more of fabrics, plastics, metals, rubbers, elastomers, or any other appropriate material choice, such as aluminum (e.g., machined aluminum), iron (e.g., steel), ceramic, or any other appropriate material. In addition to the components disclosed above, portions of tools leveraging the above teachings may be formed from molded or 3D printed plastic, metal, or combinations thereof (e.g., plastic with metal supports or fasteners coupling portions tougher). In some embodiments, structural and functional components may be formed from metal or hard plastic, while exterior-most gripped components positioned to engage the palm of a gripping hand to provide the palm with a comfortable gripping surface may be made of a suitable molded plastic material or elastomeric material, and may be generally formed as a bi-material suitable molded plastic material coated with a layer of an elastomeric material, such as a rubber-based material. In some embodiments, the material choices may differ from component to component. In various embodiments, some components may be integrally formed together, while other components may be assembled by any appropriate mechanism, including but not limited to fastened, welded, snap-fit, friction fit, adhesive bonding, or other appropriate securements.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of inventions more specifically understood in the context of the above disclosure.

What is claimed is:

1. A bar clamp comprising:
a bar;
a fixed jaw; and
a movable jaw assembly having an actuator portion and a jaw portion;
wherein the movable jaw assembly is configured to move along the bar towards or away from the fixed jaw;
wherein the actuator portion includes a trigger and a release lever; and
wherein the actuator portion is rotatable around the bar.

2. The bar clamp of claim 1, wherein the jaw portion is rotatable about the bar.

3. The bar clamp of claim 2, wherein the actuator portion comprises a mount portion that extends into the jaw portion, and is selectively locked into a rotational orientation relative to the jaw portion.

4. The bar clamp of claim 3, wherein the jaw portion comprises a jaw portion index surface that selectively aligns with a mount portion index surface formed on the mount portion to hold the jaw portion at the rotational orientation.

5. The bar claim of claim 4, wherein the jaw portion index surface is formed on a rotation actuator that moves from a first position where the jaw portion index surface is aligned with the mount portion index surface, and a second position where the jaw portion index surface is spaced from the mount portion index surface, permitting the jaw portion to rotate about the mount portion.

6. The bar clamp of claim 5, wherein the rotation actuator is spring-biased into the first position.

7. The bar clamp of claim 2, wherein the fixed jaw is removable and rotatable on the bar to align with a rotated orientation of the jaw portion of the movable jaw assembly.

8. The bar clamp of claim 1, wherein the actuator portion further includes a handle.

9. The bar clamp of claim 1, wherein the jaw portion comprises a mount portion that extends into the actuator portion, and the actuator portion is selectively locked into a rotational orientation relative to the mount portion.

10. The bar clamp of claim 9, wherein the mount portion comprises a plurality of teeth.

11. The bar clamp of claim 10, wherein the actuator portion comprises a lock that that selectively enmeshes within the plurality of teeth.

12. The bar claim of claim 11, wherein the lock is formed on a rotation actuator that moves from a first position where the lock is enmeshed with one or more of the plurality of teeth, and a second position where the lock is disengaged from the plurality of teeth, permitting the actuator portion to rotate about the mount portion.

13. The bar clamp of claim 12, wherein the rotation actuator is spring-biased into the first position.

14. The bar clamp of claim 11, wherein the lock and the plurality of teeth are shaped to prevent rotation of the actuator portion when the lock is enmeshed within the plurality of teeth, and does not permit rotation of the actuator portion about the mount portion until the lock is disengaged from the plurality of teeth.

15. A bar clamp comprising:
a bar;
a fixed jaw; and
a movable jaw assembly having an actuator portion and a jaw portion;
wherein the movable jaw assembly is configured to move along the bar towards or away from the fixed jaw;
wherein the actuator portion includes a trigger and a release lever;
wherein the actuator portion is rotatable about the bar;
wherein the jaw portion comprises a mount portion that extends into the actuator portion, and the actuator portion is selectively locked into a rotational orientation relative to the mount portion;
wherein the mount portion comprises a plurality of teeth;
wherein the actuator portion comprises a lock that that selectively enmeshes within the plurality of teeth; and
wherein the plurality of teeth and the lock are each shaped with angled sidewalls, deterring rotation of the actuator portion about the mount portion until a rotational force is applied to the actuator portion about the bar.

16. The bar clamp of claim 15, wherein the rotational force causes the angled sidewalls of the lock to slip out of the angled sidewalls of the plurality of teeth.

17. The bar clamp of claim 11, wherein the lock is spring biased into enmeshing within the plurality of teeth.

18. A method of operating a bar clamp, wherein the bar clamp comprises a bar, a fixed jaw, a movable jaw, and a movable jaw actuator, the method comprising:
rotating the movable jaw actuator about the bar while the fixed jaw and the bar remain stationary;
using the movable jaw actuator to move the movable jaw along the bar towards or away from the fixed jaw;
wherein the movable jaw actuator comprises both a trigger and a release lever.

19. The method of claim 18, wherein the bar clamp comprises a movable jaw actuator assembly housing the movable jaw actuator, wherein the movable jaw actuator assembly selectively disengages from the movable jaw to permit rotation of the one of the movable jaw actuator and the movable jaw about the bar.

20. The method of claim 18, further comprising rotating the fixed jaw about the bar prior to using the movable jaw actuator.
